(19) United States
(12) Patent Application Publication
(10) Pub. No.: US 2022/0098386 A1
(43) Pub. Date: Mar. 31, 2022

(54) RUBBER COMPOSITION AND VIBRATION DAMPING RUBBER INCLUDING RUBBER COMPOSITION VULCANIZED

(71) Applicant: Toyo Tire Corporation, Itami-shi (JP)

(72) Inventors: Hama Nagai, Itami-shi (JP); Norio Minouchi, Itami-shi (JP)

(73) Assignee: Toyo Tire Corporation, Itami-shi (JP)

(21) Appl. No.: 17/363,307

(22) Filed: Jun. 30, 2021

(30) Foreign Application Priority Data
Sep. 28, 2020 (JP) 2020-161851

(51) Int. Cl. C08K 5/40; C08L 7/00; C08K 5/372; C08K 5/3415; C08L 9/00; C08K 3/06

(52) U.S. Cl. CPC C08K 5/40; C08L 7/00; C08K 5/372; C08L 19/00; C08L 9/00; C08K 3/06; C08K 5/3415

(57) ABSTRACT

A rubber composition has a rubber component, sulfur, a bismaleimide compound, and a compound represented by Formula (I) below:

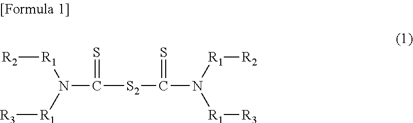

wherein R₁ is an alkylene group having 1 to 3 carbon atoms, and R₂ and R₃ are each independently an aromatic hydrocarbon or an alkyl group having 4 or more carbon atoms. The rubber composition has a content of the sulfur of 0.3 parts by mass or less based on 100 parts by mass of a total amount of the rubber component. The rubber composition preferably further has a compound represented by Formula (2) below:

[Formula 2]

R₄—S—(CH₂)ₓ—S—R₄ (2)

wherein x is an integer of 2 to 12, and R4 is a thiocarbamoyl group having an aromatic hydrocarbon or a fatty acid hydrocarbon in a molecular structure, a benzothiazole group having an aromatic hydrocarbon or a fatty acid hydrocarbon, or an —SO3−Na group.

### BACKGROUND OF THE INVENTION

### Field of the Invention

The present invention relates to a rubber composition and a vibration damping rubber including the rubber composition vulcanized. The present invention relates to a rubber composition that can be particularly suitably used as a vibration damping member such as an automobile engine mount, and to a vibration damping rubber including the rubber composition vulcanized.

### Description of the Related Art

Automobiles have increased output recently, while expected to be quiet. Automobiles are used in various environments. In some cases, automobiles are used in areas with high outside temperatures, such as Southeast Asia and Middle Eastern countries, and in some other cases, in cold regions. An automobile equipped with a vibration damping rubber containing polyisoprene rubber (IR) or natural rubber as a main component and having improved heat resistance generally does not have any particular problem when used in an area with a high outside temperature. However, if such an automobile is left in a cold region for a long time, abnormal vibration may occur at restart of the engine. Therefore, in consideration of quietness, development of a rubber composition has been awaited in which the rubber has a small amount of change in the dynamic spring constant especially at low temperature.

Patent Document 1 below describes a rubber composition for vibration damping rubbers that includes a rubber component, a sulfur-based vulcanizing agent, a resin, and a bismaleimide for the purpose of providing a rubber composition for vibration damping rubbers that is capable of suppressing a change in the dynamic spring constant with time in the range of very low temperatures.

Patent Document 2 below describes a vibration damping rubber composition including a rubber component containing diene-based rubber as a main material, a bismaleimide compound as a vulcanizing agent, and N-phenyl-N-(trichlororoethylthio)benzenesulfonamide for the purpose of providing a vibration damping rubber composition that allows the cured rubber product to have an excellent low-temperature characteristic.

Patent Document 3 below describes a vibration damping rubber composition that includes diene-based rubber, a bismaleimide, and a vulcanization accelerator and includes no sulfur element as a vulcanizing agent for the purpose of providing a vibration damping rubber composition with which excellent vibration damping performance can be obtained.

### PRIOR ART DOCUMENT

### Patent Document

[Patent Document 1] JP-A-2016-138179
[Patent Document 2] JP-A-2013-10953
[Patent Document 3] JP-A-2006-273941

### SUMMARY OF THE INVENTION

The present inventors intensively considered the above-described conventional techniques, and have found that the rubber compositions are inadequate to suppress a change in the dynamic spring constant with time at low temperature when used in a vibration damping rubber, and have room for further improvement.

The present invention has been made in view of the above-described situation, and an object of the present invention is to provide a rubber composition capable of achieving a change in the dynamic spring constant, with time at a low temperature when used in a vibration damping rubber, and provide a vibration damping rubber obtained through vulcanizing the rubber composition as a raw material.

The above-described problem can be solved by the following configuration. That is, the present invention relates to a rubber composition including a rubber component, sulfur, a bismaleimide compound, and a compound represented by Formula (1) below:

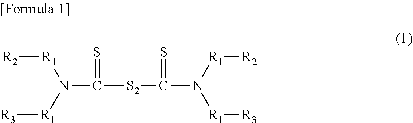

wherein R₁ is an alkylene group having 1 to 3 carbon atoms, and R₂ and R₃ are each independently an aromatic hydrocarbon or an alkyl group having 4 or more carbon atoms,

the rubber composition having a content of the sulfur of 0.3 parts by mass or less based on 100 parts by mass of a total amount of the rubber component.

The rubber composition preferably further includes a compound represented by Formula (2) below:

[Formula 2]

R₄—S—(CH₂)ₓ—S—R₄ (2)

wherein x is an integer of 2 to 12, and R₄ is a thiocarbamoyl group having an aromatic hydrocarbon or a fatty acid hydrocarbon in a molecular structure, a benzothiazole group having an aromatic hydrocarbon or a fatty acid hydrocarbon, or an —SO₃⁻Na⁺ group.

The rubber composition preferably has a content of the bismaleimide compound of 0.2 to 6 parts by mass and a content of the compound represented by Formula (1) of 0.2 to 5 parts by mass based on 100 parts by mass of the total amount of the rubber component.

The rubber composition preferably has a content of the compound represented by Formula (2) of 0.2 to 5 parts by mass based on 100 parts by mass of the total amount of the rubber component.

The present invention also relates to a vibration damping rubber including the rubber composition vulcanized.

The rubber composition according to the present invention includes 4 components, that is, a rubber component, sulfur, a bismaleimide compound, and a compound represented by Formula (1), and is particularly characterized by the following points, (i) The content of the sulfur is adjusted to 0.3 parts by mass or less based on 100 parts by mass of the total amount of the rubber component. (ii) The compound represented by Formula (1) (thiuram-based compound) is blended in which the side chain has a substituent having a large molecular weight. Regarding the point (i), by adjusting the content of the sulfur to 0.3 parts by mass or less based on 100 parts by mass of the total amount of the rubber component, the rubber composition can suppress, when used in a vibration damping rubber, a change in the dynamic spring constant with time at low temperature. Regarding the point (ii), the thiuram-based compound of the compound represented by Formula (1) has a function as a vulcanization accelerator, and the side chain in the thiuram-based compound has a substituent having a large molecular weight. This fact leads to suppression of crystallization of the rubber component at low temperature. As a result, the rubber composition can suppress a change in the dynamic spring constant with time at low temperature when used in a vibration damping rubber. That is, as a result of the effects of both the points (i) and (ii), the rubber composition according to the present invention can remarkably suppress a change in the dynamic spring constant with time at low temperature when used in a vibration damping rubber.

If the compound represented by Formula (2) is blended in the rubber composition according to the present invention (in the case of the point (iii)), the crystallization of the rubber component can be suppressed at low temperature because the compound represented by Formula (2) corresponds to a long-chain crosslinking agent. As a result, the rubber composition can further suppress a change in the dynamic spring constant with time at low temperature when used in a vibration damping rubber.

### DETAILED DESCRIPTION OF THE PREFERRED EMBODIMENTS

The rubber composition according to the present invention includes a rubber component in which polyisoprene rubber (IR) is singly used, natural rubber (NR) is singly used, or a blend of polyisoprene rubber (IR)/natural rubber and diene-based synthetic rubber is used. In the case of blending polyisoprene rubber (IR)/natural rubber and diene-based synthetic rubber, examples of the diene-based synthetic rubber include polybutadiene rubber (BR), styrene-butadiene rubber (SBR), butyl rubber (IIR), and acrylic nitrile-butadiene rubber (NBR). The polymerization method and the microstructure of the diene-based synthetic rubber are not limited, and one or more kinds of the diene-based synthetic rubber can be blended with polyisoprene rubber (IR)/natural rubber and used.

In blending polyisoprene rubber (IR)/natural rubber and diene-based synthetic rubber, the blending ratio is not particularly limited. In order to maintain the characteristic of polyisoprene rubber (IR)/natural rubber, the rubber component preferably contains polyisoprene rubber (IR)/natural rubber at a content of 50% by weight or more, and more preferably 90% by weight or more. Examples of the rubber that can be used as a rubber component include, in addition to polyisoprene rubber (IR)/natural rubber and diene-based synthetic rubber, synthetic rubbers including olefin-based rubber such as ethylene-propylene rubber (EPM), halogenated butyl rubber such as brominated butyl rubber (Br-IIR), polyurethane rubber, acrylic rubber, fluororubber, silicon rubber, chlorosulfonated polyethylene, and the like.

The rubber composition according to the present invention includes sulfur. The sulfur may be ordinary sulfur for rubber, and sulfur such as powdered sulfur, precipitated sulfur, insoluble sulfur, and highly dispersible sulfur can be used. The content of the sulfur in the rubber composition according to the present invention is 0.3 parts by mass or less, and preferably 0.1 to 0.3 parts by mass based on 100 parts by mass of the total amount of the rubber component.

The rubber composition according to the present invention includes a bismaleimide. As the bismaleimide, compounds known to those skilled in the art can be used, and a bismaleimide can be particularly suitably used that is represented by the following general formula (1):

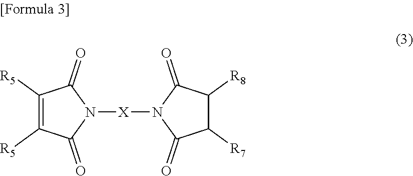

wherein R₅ to R₈ each represent a hydrogen atom, an alkyl group, an amino group, a nitro group, or a nitroso group and may be the same or different from each other, and X represents a divalent organic group. Specific examples of the bismaleimide that can be used in the present invention include N,N′-M-phenylene bismaleimide, N,N′-(4,4′-diphenylmethane)bismaleimide, bis(3-ethyl-5-methyl-4-maleimidephenyl)methane, and 2,2′-bis(4-(4-maleimidephenoxy)phenyl)propane. The content of the bismaleimide is preferably 0.2 to 6 parts by mass, and more preferably 0.5 to 3 parts by mass based on 100 parts by mass of the total amount of the rubber component.

The rubber composition according to the present invention includes a compound represented by Formula (1) below:

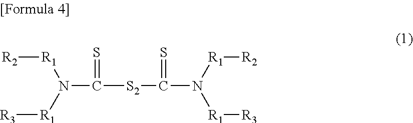

wherein R₁ is an alkylene group having 1 to 3 carbon atoms, and R₂ and R₃ are each independently an aromatic hydrocarbon or an alkyl group having 4 or more carbon atoms. The compound represented by Formula (1) is a thiuram-based compound in which the side chain has a substituent having a large molecular weight, and specific examples of the compound include tetrakis(2-ethylhexyl)thiuram disulfide, tetrabenzyl thiuram disulfide, and tetrabutyl thiuram disulfide. The content of the compound represented by Formula (1) is preferably 0.2 to 5 parts by mass, and more preferably 0.5 to 5 parts by mass based on 100 parts by mass of the total amount of the rubber component.

The rubber composition according to the present invention includes a compound represented by Formula (2) below:

[Formula 5]

R₄—S—(CH₂)ₓ—S—R₄ (2)

wherein x is an integer of 2 to 12, and R₄ is a thiocarbamoyl group having an aromatic hydrocarbon or a fatty acid hydrocarbon in a molecular structure, a benzothiazole group having an aromatic hydrocarbon or a fatty acid hydrocarbon, or an —SO₃⁻Na⁺ group. Examples of the compound represented by Formula (2) include 1,6-bis(N,N′-dibenzylthiocarbamoyldithio)hexane. The content of the compound represented by Formula (2) is preferably 0.2 to 5 parts by mass, and more preferably 0.5 to 3 parts by mass based on 100 parts by mass of the total amount of the rubber component.

In the rubber composition according to the present invention, a compounding agent that is known to those skilled in the art and usually used in the rubber industry can be appropriately blended and used in addition to the rubber component, sulfur, the bismaleimide compound, the compound represented by Formula (1), and the compound represented by Formula (2) as long as an effect of the present invention is not impaired. Examples of the compounding agent include carbon black, vulcanization accelerators other than the compound represented by Formula (1), silica, silane coupling agents, zinc oxide, stearic acid, vulcanization retarders, organic peroxides, anti-aging agents, softeners such as waxes and oils, and processing aids.

As the carbon black, carbon black known to those skilled in the art can be used, and for example, SAF, ISAF, HAF, FEF, GPF, and the like are used. The content of the carbon black is preferably 30 to 100 parts by mass, and more preferably 30 to 60 parts by mass based on 100 parts by mass of the total amount of the rubber component.

As the vulcanization accelerator other than the compound represented by Formula (1), vulcanization accelerators usually used for rubber vulcanization may be used singly or in appropriate combination. Examples of the vulcanization accelerators include sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators.

As the anti-aging agent, anti-aging agents usually used for rubber may be used singly or in appropriate combination. Examples of the anti-aging agents include aromatic amine-based anti-aging agents, amine-ketone-based anti-aging agents, monophenol-based anti-aging agents, bisphenol-based anti-aging agents, polyphenol-based anti-aging agents, dithiocarbamate-based anti-aging agents, and thiourea-based anti-aging agents.

The rubber composition according to the present invention is obtained through kneading the rubber component, sulfur, the bismaleimide compound, the compound represented by Formula (1), the compound represented by Formula (2), and if necessary, carbon black, a vulcanization accelerator other than the compound represented by Formula (1), silica, a silane coupling agent, zinc oxide, stearic acid, a vulcanization retarder, an organic peroxide, an anti-aging agent, a softener such as a wax or an oil, a processing aid, and the like using an ordinary kneader used in the rubber industry.

The method of blending the above-described components is not particularly limited, and a method may be used, for example, in which compounding components other than vulcanization components, such as sulfur and a vulcanization accelerator, are kneaded in advance to form a masterbatch, and the remaining components are added and further kneaded, or in which the components are added in an arbitrary order and kneaded, or in which all components are simultaneously added and kneaded.

The above-described components are kneaded, the resulting mixture is molded, and then the molded product is vulcanized to obtain a vibration damping rubber in which a change in the dynamic spring constant with time is suppressed at low temperature. Such a vibration damping rubber can be suitably used as vibration damping rubbers and seismic isolation rubbers such as vibration damping rubbers for automobiles such as engine mounts, torsional dampers, body mounts, cap mounts, member mounts, strut mounts, and muffler mounts, and in addition, vibration damping rubbers for railway vehicles, vibration damping rubbers for industrial machinery, seismic isolation rubbers for construction, and seismic isolation rubber supports. Such a vibration damping rubber is particularly useful as a structural member of vibration damping rubbers for automobiles in which reduction in the dynamic magnification and tear resistance are to be improved.

### EXAMPLES

Hereinafter, the present invention will be described in more detail with reference to Examples.

### (Preparation of Rubber Composition)

A rubber composition in each of Examples 1 to 16 and Comparative Examples 1 to 3 was blended with 100 parts by mass of a rubber component in accordance with the compounding formulation shown in Table 1, and the resulting mixture was kneaded using an ordinary Banbury mixer to prepare the rubber composition. The compounding agents shown in Table 1 are as follows.

Polymer: product name “IR2200L” manufactured by Zeon Corporation

Carbon black: product name “SEAST V” manufactured by TOKAI CARBON CO., LTD.

Silica: product name “UltrasilVN3” manufactured by Evonik industries AG

Wax: product name “OZOACE 2701” manufactured by Nippon Seiro Co., Ltd.

Zinc oxide: product name “Zinc White No. 3” manufactured by MITSUI MINING & SMELTING CO., LTD.

Fatty acid: product name “Industrial Stearic Acid” manufactured by Kao Corporation

Anti-aging agent 1: product name “NOCRAC 6C” manufactured by OUCHI SHINKO CHEMICAL INDUSTRIAL CO., LTD.

Anti-aging agent 2: product name “ANTAGE RD” manufactured by Kawaguchi Chemical Industry Co., Ltd.

Sulfur: product name “5% Oil-Treated Sulfur” manufactured by Hosoi Chemical Industry Co., Ltd.

Vulcanization accelerator 1: product name “NOCCELER DM-P (DM)” manufactured by ouchi shinko chemical industrial CO., LTD.

Vulcanization accelerator 2: product name “NOCCELER CZ-G (CZ)”8 manufactured by ouchi shinko chemical industrial CO., LTD.

Vulcanization accelerator 3: product name “NOCCELER TT-P (TT)” manufactured by OUCHI SHINKO CHEMICAL INDUSTRIAL CO., LTD.

Vulcanization accelerator 4: product name “NOCCELER TS” manufactured by OUCHI SHINKO CHEMICAL INDUSTRIAL CO., LTD.

Vulcanization accelerator 5 (tetrabenzyl thiuram disulfide) (compound represented by Formula (1)): product name “SANCELER TBZTD” manufactured by SANSHIN CHEMICAL INDUSTRY CO., LTD.

Vulcanization accelerator 6 (tetrakis(2-ethylhexyl)thiuram disulfide) (compound represented by Formula (1)): product name “NOCCELER TOT-N” manufactured by OUCHI SHINKO CHEMICAL INDUSTRIAL CO., LTD.

Crosslinking aid (N,N-(4,4-diphenylmethane)bismaleimide): product name “BMI” manufactured by K.I Chemical Industry Co., Ltd.

Co-crosslinking agent 1 (1,6-bis(N,N′-dibenzylthiocarbamoyldithio)hexane) (compound represented by Formula (2)): product name “KA9188” manufactured by LANXESS

Co-crosslinking agent 2 (sodium hexamethylene-1,6-bisthiosulfate dihydrate): product name “Duralink-HTS” manufactured by Flexsys

### Examples 1 to 16 and Comparative Examples 1 to 3

Each rubber composition was evaluated under the following conditions. In the production of vulcanized rubber, vulcanization was performed under the vulcanization conditions of heating at 170° C. for 13 minutes.

### [Low-Temperature Characteristic]

Each rubber composition was press-molded while vulcanized to prepare a vulcanized rubber sample having a columnar shape (diameter 50 mm, height 25 mm). The obtained test piece was compressed in the direction of the column axis by 2.5 mm at normal temperature, the position after the 2.5 mm compression was set as the center, a constant-displacement harmonic compressive vibration with an amplitude of 0.05 mm was applied at a frequency of 100 Hz from below, the dynamic load was detected with a load cell set above, and an initial dynamic spring constant (Kd) (N/mm) at normal temperature was calculated in accordance with JIS-K 6394. Next, the sample whose initial dynamic spring constant at normal temperature was measured was left at −30° C. for 240 hours, and then the dynamic spring constant (Kd) (N/mm) at low temperature was calculated under the same conditions. The rate of change from the initial dynamic spring constant (Kd) at normal temperature to the dynamic spring constant (Kd) at low temperature was calculated. The low-temperature characteristic (the effect of suppressing a change in the dynamic spring constant with time at low temperature) in each Example was evaluated using an index determined as the proportion of the rate of change to the rate of change that was calculated using the vulcanized rubber of the rubber composition in Comparative Example 1 and set to 100. The smaller the index is, the better the low-temperature characteristic is. Table 1 shows the results.

TABLE 1

| | Comparative | Comparative | Comparative | Example | Example | Example | Example | Example | Example | Example |
|---|---|---|---|---|---|---|---|---|---|---|
| | Example 1 | Example 2 | Example 3 | 1 | 2 | 3 | 4 | 5 | 6 | 7 |
| Polymer | 100 | 100 | 100 | 100 | 100 | 100 | 100 | 100 | 100 | 100 |
| Carbon black | 40 | 40 | 40 | 40 | 40 | 40 | 40 | 40 | 40 | 40 |
| Silica | | | | | | | | | | |
| Wax | 2 | 2 | 2 | 2 | 2 | 2 | 2 | 2 | 2 | 2 |
| Zinc oxide | 5 | 5 | 5 | 5 | 5 | 5 | 5 | 5 | 5 | 5 |
| Fatty acid | 3 | 3 | 3 | 3 | 3 | 3 | 3 | 3 | 3 | 3 |
| Anti-aging agent 1 | 2 | 2 | 2 | 2 | 2 | 2 | 2 | 2 | 2 | 2 |
| Anti-aging agent 2 | 2 | 2 | 2 | 2 | 2 | 2 | 2 | 2 | 2 | 2 |
| Sulfur | 0.3 | 0.3 | 0.5 | 0.3 | 0.3 | 0.3 | 0.3 | 0.2 | 0.3 | 0.3 |
| Accelerator 1 | 2 | 2 | 2 | 2 | 2 | 2 | 2 | 2 | 2 | 2 |
| Accelerator 2 | | | | | | | | | | |
| Accelerator 3 | 0.5 | | | | | | | | | |
| Accelerator 4 | | 0.5 | | | | | | | | |
| Accelerator 5 | | | | 0.2 | 0.5 | 1 | 4 | | 1 | 1 |
| Accelerator 6 | | | 3 | | | | | 3 | | |
| Crosslinking aid | 2 | 2 | 2 | 2 | 2 | 2 | 2 | 2 | 0.2 | 0.5 |
| Co-crosslinking | | | | | | | | | | |
| agent 1 | | | | | | | | | | |
| Co-crosslinking | | | | | | | | | | |
| agent 2 | | | | | | | | | | |
| low-temperature | 100 | 87 | 70 | 60 | 41 | 38 | 37 | 47 | 35 | 49 |
| characteristic | | | | | | | | | | |

| | Example | Example | Example | Example | Example | Example | Example | Example | Example |
|---|---|---|---|---|---|---|---|---|---|
| | 8 | 9 | 10 | 11 | 12 | 13 | 14 | 15 | 16 |
| Polymer | 100 | 100 | 100 | 100 | 100 | 100 | 100 | 100 | 100 |
| Carbon black | 40 | 40 | 40 | 40 | 40 | 40 | 40 | 40 | 40 |
| Silica | | | | | | | | | 5 |
| Wax | 2 | 2 | 2 | 2 | 2 | 2 | 2 | 2 | 2 |
| Zinc oxide | 5 | 5 | 5 | 5 | 5 | 5 | 5 | 5 | 5 |
| Fatty acid | 3 | 3 | 3 | 3 | 3 | 3 | 3 | 3 | 3 |
| Anti-aging agent 1 | 2 | 2 | 2 | 2 | 2 | 2 | 2 | 2 | 2 |
| Anti-aging agent 2 | 2 | 2 | 2 | 2 | 2 | 2 | 2 | 2 | 2 |
| Sulfur | 0.3 | 0.3 | 0.3 | 0.3 | 0.3 | 0.2 | 0.3 | 0.3 | 0.3 |
| Accelerator 1 | 2 | 2 | 2 | 2 | 2 | 2 | 2 | 1 | 2 |
| Accelerator 2 | | | | | | | | 1 | |
| Accelerator 3 | | | | | | | | | |
| Accelerator 4 | | | | | | | | | |
| Accelerator 5 | 1 | 1 | 1 | 1 | 1 | | | 1 | 1 |
| Accelerator 6 | | | | | | 3 | 3 | | |
| Crosslinking aid | 3 | 6 | 2 | 2 | 2 | 2 | 2 | 2 | 2 |
| Co-crosslinking | | | 0.5 | 1 | 3 | 0.5 | | 0.5 | 0.5 |
| agent 1 | | | | | | | | | |
| Co-crosslinking | | | | | | | 1 | | |
| agent 2 | | | | | | | | | |
| low-temperature | 44 | 36 | 30 | 29 | 15 | 33 | 36 | 34 | 38 |
| characteristic | | | | | | | | | |

From the results shown in Table 1, it is found that the vulcanized rubber of the rubber composition in Examples 1 to 16 is excellent in the low-temperature characteristic (the effect of suppressing a change in the dynamic spring constant with time at low temperature). In particular, it is found that in Examples 10 to 16 in which the rubber component, sulfur, the bismaleimide compound, and a combination of the compound represented by Formula (1) and the compound represented by Formula (2) were blended, the low-temperature characteristic is extremely excellent. Meanwhile, the vulcanized rubber of the rubber composition in Comparative Example 2 had a low effect of improving the low-temperature characteristic. In Comparative Example 3, although the rubber composition included the compound represented by Formula (1), the vulcanized rubber also had a low effect of improving the low-temperature characteristic because the blending amount of sulfur was large.

What is claimed is:

1. A rubber composition comprising a rubber component, sulfur, a bismaleimide compound, and a compound represented by Formula (1) below: 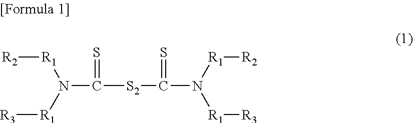
wherein R₁ is an alkylene group having 1 to 3 carbon atoms, and R₂ and R₃ are each independently an aromatic hydrocarbon or an alkyl group having 4 or more carbon atoms,
the rubber composition having a content of the sulfur of 0.3 parts by mass or less based on 100 parts by mass of a total amount of the rubber component.

2. The rubber composition according to claim 1, further comprising a compound represented by Formula (2) below:
[Formula 2]
R₄—S—(CH₂)ₓ—S—R₄ (2)
wherein x is an integer of 2 to 12, and R₄ is a thiocarbaraoyl group having an aromatic hydrocarbon or a fatty acid hydrocarbon in a molecular structure, a benzothiazole group having an aromatic hydrocarbon or a fatty acid hydrocarbon, or an —SO₃⁻Na⁺ group.

3. The rubber composition according to claim 1, having a content of the bismaleimide compound of 0.2 to 6 parts by mass and a content of the compound represented by Formula (1) of 0.2 to 5 parts by mass based on 100 parts by mass of the total amount of the rubber component.

4. The rubber composition according to claim 2, having a content of the compound represented by Formula (2) of 0.2 to 5 parts by mass based on 100 parts by mass of the total amount of the rubber component.

5. A vibration damping rubber comprising the rubber composition according to claim 1, the rubber composition vulcanized.
